(19) United States
(12) Patent Application Publication
(10) Pub. No.: US 2026/0044047 A1
(43) Pub. Date: Feb. 12, 2026

(54) ADAPTING OPTICAL PROPERTIES OF A CONTINUOUS BODY COMPRISING NONLINEAR OPTICAL MATERIAL TO LIGHT OF DIFFERENT WAVELENGTHS BY ADJUSTING A TEMPERATURE DISTRIBUTION IN THE CONTINUOUS BODY

(71) Applicant: Max-Planck-Gesellschaft zur Förderung der Wissenschaften e.V., München (DE)

(72) Inventor: Fabian Meylahn, Hamburg (DE)

(73) Assignee: Max-Planck-Gesellschaft zur Förderung der Wissenschaften e.V., München (DE)

(21) Appl. No.: 19/296,711

(22) Filed: Aug. 11, 2025

(30) Foreign Application Priority Data
Aug. 12, 2024 (EP) 24194063.4

(51) Int. Cl. G02F 1/35

(52) U.S. Cl. CPC G02F 1/3501; G02F 2203/15

(57) ABSTRACT

For adapting optical properties of a continuous body arranged in a resonator cavity and comprising a nonlinear optical material to light of two different wavelengths passing through the continuous body along an optical axis, the continuous body having a total length along the optical axis, a spatially constant temperature is adjusted in a first region of the continuous body, the first region extending over at least 20% of the total length, and a temperature gradient is adjusted in a second region of the continuous body, the second region neighboring the first region and extending over at least 10% of the total length. The temperature gradient may be selected such as to achieve resonance of the light of both wavelengths in the resonator cavity.

### CROSS REFERENCE TO RELATED APPLICATIONS

The present application claims priority to European Patent Application EP 24 194 063.4, filed Aug. 12, 2024 and entitled “Adapting optical properties of a continuous body comprising nonlinear optical material to light of different wavelengths by adjusting a temperature distribution in the continuous body,” the disclosure of which is incorporated herein by reference in its entirety.

### FIELD OF THE INVENTION

Various embodiments of the invention relate to a method of adapting optical properties of a continuous body arranged in a resonator cavity and comprising a nonlinear optical material to light of two different wavelengths passing through the continuous body along an optical axis.

Further, particular embodiments relate to an optical resonator comprising a resonator cavity extending along an optical axis, and a continuous body made of a nonlinear optical material arranged in the resonator cavity.

In order to achieve a high interaction between the optical fields of light of two different wavelengths in a nonlinear optical material, phase-matching of the optical fields is required. Further, if the nonlinear material is arranged in a resonator, this resonator is to be tuned to at least one of the different wavelengths, and preferably to both different wavelengths.

### BACKGROUND OF THE INVENTION

U.S. Pat. No. 5,898,718 discloses a light emitting device comprising a nonlinear harmonic generator optical structure which receives light of a plurality of primary frequencies at an input end thereof and which emits light of a plurality of second frequencies that are harmonics of the primary frequencies at an output end thereof. The light emitting device further comprises at least two heat exchange means, each of which is adapted to exchange thermal energy between the heat exchange means and a section of the optical structure. The heat exchange means are structured to independently control the overall temperature of the sections of the optical structure along the length of the optical structure, and also to independently control the energy exchange applied to the individual sections. The heat exchange means are therefore structured to independently set and maintain upon command the sections of the optical structure at the appropriate overall temperature to generate light at a desired harmonic frequencies of one of said primary light frequencies, and to apply more heat near the input end than to the output end of each section to optimize the output power of the harmonic frequency generated by each section. Further, U.S. Pat. No. 5,898,718 discloses a method of obtaining and optimizing output light at a plurality of harmonic frequencies from the nonlinear optical structure. The method comprises introducing light of a plurality of primary frequencies into an input end of the optical structure; applying heat to a first section of the optical structure and modifying the application of heat to obtain output light at a desired first harmonic frequency, applying heat differentially along the length of the first section at a plurality of separate locations, with more heat being applied near the input end than near the output end of the first section of the optical structure to optimize the first desired harmonic light output. Further, the method comprises applying heat to a second section of that optical structure and modifying the application of heat to obtain output harmonic light at a desired second harmonic frequency, and applying heat differentially along the length of the second section of the optical structure, with more heat being applied near the input end than near the output end of the second section to optimize the output of harmonic light at the desired second frequency. The first and second desired harmonic lights are obtained simultaneously or sequentially one at a time. When the first and second desired harmonic lights are obtained simultaneously, said first and second segments are separated segments of the optical structure. The light emitting device disclosed in U.S. Pat. No. 5,898,718 comprises no resonator.

Unites States patent application publication US 2017/0 269 389 A1 discloses an apparatus for generating electromagnetic radiation comprising a pump laser for generating electromagnetic continuous-wave pump radiation, and an optical parametric oscillator having a nonlinear optical crystal. The optical parametric oscillator is arranged in a beam path of the pump radiation; and the optical parametric oscillator generates signal radiation and idler radiation from the pump radiation. The nonlinear optical crystal is arranged in the resonator, and the resonator is resonant for the wavelength of the signal radiation or the idler radiation generated in the optical parametric oscillator. The nonlinear optical crystal of the optical parametric oscillator is arranged in a furnace with temperature stabilization. The wavelength of the signal radiation or the idler radiation generated in the optical parametric oscillator is tuned by way of selecting the temperature of the nonlinear optical crystal in the optical parametric oscillator. Further, the apparatus comprises a nonlinear optical device having a further nonlinear optical crystal. The nonlinear optical device is arranged in a beam path of at least one of the signal radiation and the idler radiation. The nonlinear optical device generates electromagnetic radiation from the signal radiation or the idler radiation at a frequency greater than a frequency of the signal radiation or the idler radiation. The nonlinear optical crystal of the nonlinear optical device is arranged in a furnace which heats the crystal in such a way that the crystal has a temperature gradient in the beam direction of the signal radiation or idler radiation. A controller is connected to the furnace and to a temperature sensor that is arranged to detect a temperature of the crystal of the optical parametric oscillator. The controller controls the temperature gradient of the crystal of the nonlinear optical device depending on the temperature of the crystal of the optical parametric oscillator. The nonlinear optical device has a resonator having a plurality of mirrors.

Unites States patent application publication US 2018/0 081 256 A1 discloses a tunable monolithic cavity-based frequency converter pumped by a single-frequency laser, in which cavity resonances are achieved by independently changing the temperatures of different sections of a nonlinear crystal. The different sections include a periodically poled active section and one or more adjacent, non-poled side sections. The temperature of the active section is controlled for phase-matching, and the temperatures of the one or more side sections are controlled for the cavity resonance of at least a down-converted beam. Means for controlling the temperature are thin layer resistors made of a conductor deposited on a support in contact with the crystal.

Unites States patent application publication US 2021/0 234 329 A1 discloses a device for generating laser radiation comprising a temperature-controlled optical setup including an optically nonlinear solid state medium arranged in a resonator and having an active region. The outgoing laser radiation is generated from a pump beam introduced into the optically nonlinear solid state medium. A first temperature actuator and a second temperature actuator are configured to independently adjust temperature values in the active region of the optically nonlinear solid state medium. The first temperature actuator is configured to regulate a length of the resonator by setting a first temperature value within a first portion of the active region. The second temperature actuator is configured to match phases of wavelengths generated by the outgoing laser radiation and phases of wavelengths of the pump beam radiation by setting a second temperature value within a second portion of the active region. US 2021/0 234 329 A1further comprises a method of generating laser radiation using a temperature-controlled optical setup. The method comprises providing a resonator comprising an optically nonlinear solid state medium having an active region, introducing pump beam radiation into the optically nonlinear solid state medium of the resonator, generating outgoing wavelengths of laser radiation from the optically nonlinear solid state medium of the resonator, adjusting a resonator length by setting a first temperature value within a first section of an active region of the resonator, and matching phases of the generated wavelengths and wavelengths of the introduced pump beam radiation by setting a second temperature value within a second section of the active region of the resonator. The active region extends over the optically nonlinear solid state medium. The resonator may comprise a first resonator mirror and a second resonator mirror positioned on outer sides of opposite ends of the optically nonlinear solid state medium. The method may further comprise adjusting the resonator length by regulating a third temperature within a third section of the active region and a fourth temperature within a fourth section of the active region of the resonator.

If a temperature of a continuous body made of a nonlinear optical material is set to a first value in a first region to achieve optimal phase-matching, and if the temperature of the same continuous body is set to a second value in an adjacent or neighboring region of the continuous body for resonance in the resonator, a steep temperature gradient or temperature step is generated between the adjacent regions in the nonlinear optical material. This steep temperature gradient results in thermal stress which may potentially deform the wavefronts of the transmitted light or lead to mechanical damage to the nonlinear optical material if the temperature difference and thus the thermal stress becomes too high. Further, a thermal insulation layer or air gap is needed between the adjacent regions so that no continuous mechanical support for the continuous body is possible.

Thus, there is a need of a method and an optical resonator overcoming these disadvantages.

### SUMMARY OF THE INVENTION

In one aspect, the present invention relates to a method of adapting optical properties of a continuous body arranged in a resonator cavity and comprising a nonlinear optical material to light of two different wavelengths passing through the continuous body along an optical axis, the continuous body having a total length along the optical axis. The method comprises adjusting a spatially constant temperature in a first region of the continuous body. The first region comprises the nonlinear optical material and extends over at least 20% of the total length of the continuous body along the optical axis. The method further comprises adjusting a first temperature gradient along the optical axis in a second region of the continuous body. The first temperature gradient starts from the spatially constant temperature in the first region. The second region neighbors the first region on a first side of the first region and extends over at least 10% of the total length of the continuous body along the optical axis.

In another aspect, the present invention relates to an optical resonator comprising a resonator cavity extending along an optical axis between at least two mirrors, a continuous body comprising a nonlinear optical material arranged in the resonator cavity and having a total length along the optical axis, and a first temperature adjusting device configured for adjusting a spatially constant temperature in a first region of the continuous body. The first region comprises the nonlinear optical material and extends over at least 20% of the total length of the continuous body along the optical axis. The optical resonator further comprises a second temperature adjusting device configured for adjusting a first temperature gradient along the optical axis in a second region of the continuous body. The first temperature gradient starts from the spatially constant temperature in the first region. The second region neighbors the first region on a first side of the first region and extends over at least 10% of the total length of the continuous body along the optical axis.

Other features and advantages of the present invention will become apparent to one with skill in the art upon examination of the following drawings and the detailed description. It is intended that all such additional features and advantages be included herein within the scope of the present invention, as defined by the claims.

### BRIEF DESCRIPTION OF THE DRAWINGS

The invention can be better understood with reference to the following drawings. The components in the drawings are not necessarily to scale, emphasis instead being placed upon clearly illustrating the principles of the present invention. In the drawings, like reference numerals designate corresponding parts throughout the several views.

FIG. 1 is a side view of a first embodiment of an optical resonator according to the present invention;

FIG. 2 shows details of the optical resonator of FIG. 1 and a temperature distribution over a continuous body made of a nonlinear optical material;

FIG. 3 is a side view of a further embodiment of the optical resonator according to the present invention; and

FIG. 4 is a side view of an even further embodiment of the optical resonator according to the present invention.

### DETAILED DESCRIPTION

The present disclosure relates to a method of adapting optical properties of a continuous body, that is arranged in a resonator cavity and made of a nonlinear optical material, to light of two different wavelengths passing through the continuous body along an optical axis. The continuous body is a solid body. The continuous body may be homogenous, i.e., comprise a homogenous or at least quasi-homogenous composition along the optical axis. Thus, the entire continuous body may be made of the nonlinear optical material, or of the nonlinear optical material and a further material which may have a same composition but not be nonlinear. For example, the nonlinear optical material may be a periodically poled nonlinear optical material. The nonlinear optical material will be a crystal. Particularly, the nonlinear optical material may be a periodically poled crystal. The continuous body has a total length along the optical axis.

In the method, a spatially constant temperature is adjusted in a first region of the continuous body. The first region comprises the nonlinear optical material and extends over at least 20% of the total length of the continuous body. The feature that the first region in which the spatially constant temperature is adjusted extends over at least 20% of the total length of the continuous body means that the first region extends over an essential part of the total length of the continuous body. Thus, the spatially constant temperature is constant over an essential part of the total length of the continuous body. Typically, the spatially constant temperature which is adjusted in the entire first region of the continuous body will also be temporarily constant, i.e., constant over periods of time over which the method is implemented for a particular purpose, i.e., over which light is coupled out of the resonator cavity for a particular purpose.

Particularly, the spatially constant temperature that is adjusted in the first region of the continuous body will be selected such as to achieve phase-matching between the light of the two different wavelengths in the first region. Thus, the first region will be or include the region of maximum interaction between the light of the two different wavelengths within the resonator cavity. The light of the two different wavelengths may, for example, be light of a laser beam injected into the resonator cavity as pump light and light generated in the generator using the pump light but at a wavelength differing from the wavelength of the pump light. The light generated may form a further laser beam that can be coupled out of the resonator cavity. The frequency of the light generated may be a harmonic of the pump light, or the result of a sum or difference frequency generation and opto-parametric amplification or oscillation.

In the method, a first temperature gradient is adjusted in a second region of the continuous body. The second region neighbors the first region on a first side of the first region and extends over at least 10% of the total length of the continuous body. Although the second region neighbors the first region, it may or it may not comprise the nonlinear optical material. For example, the second region may comprise a material of a same chemical composition as the nonlinear optical material in the first region but without periodical poling. The material of the second region may even have another composition than the nonlinear optical material in the first region. However, preferably, the second region comprises the same nonlinear optical material as the first region. The feature that the second region of the continuous body extends over at least 10% of the total length of the continuous body indicates that the first temperature gradient is adjusted over a relevant part of the continuous body. This part of the continuous body covered by the second region along the optical axis may even be larger than the part of the continuous body covered by the first region along the optical axis. However, typically, the second region will not be larger and, often, it will be smaller than the first region. The first temperature gradient that is adjusted in the second region of the continuous body will be selected such as to achieve resonance of the light of the two different wavelengths in the resonator cavity.

Particularly, the first temperature gradient may be selected such as to contribute to a resonance of the light of both different wavelengths. The first temperature gradient in the second regions directly starts from the spatially constant temperature in the first region, i.e. without any significant temperature jump between the first and second regions. Further, there will only be a small curved temperature course along the optical axis, which, for physical reasons, cannot be omitted completely. The first temperature gradient provides for an additional degree of freedom in adapting the optical properties of the continuous body in the resonator cavity to the light of the two different wavelengths. This single additional degree of freedom may not be sufficient to achieve resonance of the light of both of the two different wavelengths in the resonator cavity if the length of the resonator is not controlled or the pump laser frequency is not tuned to resonance.

A further degree of freedom in adapting the optical properties of the continuous body may be provided in that a second temperature gradient is adjusted in a third region of the continuous body. The third region preferably neighbors the first region on the second side of the first region that faces away from the first side of the first region. The third region also extends over at least 10% of the total length of the continuous body; and the second temperature gradient will also be selected such as to achieve resonance of the light of the two different wavelengths in the resonator cavity. The feature that the third region of the continuous body extends over at least 10% of the total length of the continuous body has the same meaning as the corresponding feature of the second region of the continuous body.

The first region and the second region, or the first, second and third regions, respectively, may be the only regions of the continuous body along the optical axis. However, there may be at least one other region of the continuous body.

Adjusting a temperature or adjusting a temperature gradient is to be understood as taking the necessary measures such as to achieve and maintain the respective temperature or temperature gradient.

Typically, the spatially constant temperature adjusted in the first region of the continuous body will be constant in that a spatial and also a temporal temperature variation over the first region will be smaller than 0.5 K. Often, this temperature variation over the first region will be smaller than 0.1 K, and preferably, it will be smaller than 10 mK. Further, the spatially constant temperature adjusted in the first region of the continuous body will be in a range from 18° C. to 150° C. Preferably, it will be in a range from 22° C. to 80° C. However, it will be understood that the spatially constant temperature to be selected for phase-matching between the light of the two different wavelengths will depend on the nonlinear optical material in the first region and on the two different wavelengths.

The first temperature gradient adjusted in the second region is either positive or negative. Typically, the first temperature gradient adjusted in the second region will result in a temperature difference of at least 1 K over the second region. Further, the first temperature gradient adjusted in the second region will be at least 0.1 K/mm. Often, the first temperature gradient adjusted in the second region will have a value in a range from 0.5 K/mm to 10 K/mm, and preferably in a range from 1 K/mm to 4 K/mm. The same applies to the second temperature gradient adjusted in the third region of the continuous body. In any case, the temperature gradient to be selected for resonance of the light of the two different wavelengths in the resonator cavity depends on the optical material in the respective region of the respective temperature gradient, on the two different wavelengths, and on the length of the respective region of the continuous body along the optical axis.

Generally, the first or second temperature gradient may be any defined temperature gradient over the second or third region of the continuous body. However, most preferably, all adjusted temperature gradients are spatially constant temperature gradients resulting in a linear course of the temperature of the optical material in the respective region along the optical axis, and, thus, in a most defined effect on the optical properties of the continuous body in the resonator cavity. The spatial constancy of the temperature gradients, at least essentially, ensures that the relevant optical properties of the optical material in the respective region of the continuous body uniformly vary over the extension of the respective region along the optical axis in a defined and controlled way. This is a big advantage with regard to achieving the desired resonance of the light of the two different wavelengths in the resonator cavity in a controlled way by adjusting the temperature gradients. Typically, the spatially constant temperature gradient, i.e., the constant value of the temperature gradient which is adjusted in the entire first region of the continuous body, will be not only spatially constant but also temporarily constant, i.e., constant over periods of time over which the method is implemented for a particular purpose, i.e., over which light is coupled out of the resonator cavity for a particular purpose.

An optical resonator according to the present disclosure comprises a resonator cavity extending along an optical axis between at least two mirrors. The at least two mirrors are aligned to allow for a closed optical beam path that defines the optical axis. The simplest configuration of the at least two mirrors is a first mirror arranged at a first cavity end and a second mirror arranged at a second cavity end. The optical resonator further comprises a continuous body comprising a nonlinear optical material arranged in the resonator cavity and having a total length along the optical axis, a first temperature adjusting device configured for adjusting a spatially constant temperature in a first region of the continuous body, and a second temperature adjusting device configured for adjusting a first temperature gradient in a second region of the continuous body. The first region of the continuous body comprises the nonlinear optical material and extends over at least 20% of the total length of the continuous body along the optical axis. The second region neighbors the first region on a first side of the first region and extends over at least 10% of the total length of the continuous body along the optical axis. The continuous body may be a homogenous continuous body completely consisting of the nonlinear optical material. At least, the continuous body comprises the nonlinear optical material in its first region.

Additionally, the optical resonator may comprise a third temperature adjusting device configured for adjusting a second temperature gradient in a third region of the continuous body. Preferably, the third region of the continuous body neighbors the first region on a second side of the first region that faces away from the first side of the first region. Same as the second region, the third region extends over at least 10% of the total length of the continuous body along the optical axis.

The meaning of these features and other advantageous features of the optical resonator according to the present may be derived from the above description of the method according to the present disclosure.

Further, the at least two mirrors at the first and second ends of the resonator cavity may be concave mirrors, i.e., have a concave curvature of their reflecting surfaces at the cavity ends, and they may be configured for focusing light coming out of a subregion of the first region of the continuous body back into that subregion. At least one or even both of the at least two mirrors may be provided on an end face of the continuous body. Thus, the optical resonator may comprise a monolithic construction of the resonator cavity including the continuous body comprising the nonlinear optical material, and of the at least two mirrors.

Each temperature adjusting device of the optical resonator may comprise at least one temperature sensor, at least one of a heating element and a thermo-electric-cooler which may also be used as a heating element, like for example a Peltier element, and a temperature controller operating the heating element and/or the Peltier element depending on a temperature sensed by the temperature sensor and a target temperature or target temperature difference. Alternatively, sensing of the involved light fields can be used to control some of the heating elements or thermo-electric-coolers, i.e., the Pound-Drever-Hall method can be used to sense whether a laser field is resonant in the resonator.

In an embodiment, the first temperature adjusting device may further comprise a temperature equalizer made of a high thermal conductivity material and continuously contacting the continuous body along the optical axis over the first region. The high thermal conductivity material comprises a high specific thermal conductivity much higher than a specific thermal conductivity of the nonlinear optical material. The temperature equalizer quickly compensates any difference in temperature within the first region by a heat flow through the high thermal conductivity material that is actually driven by the difference in temperature. The high thermal conductivity material may, by more than 50% by weight, i.e., essentially, consist of copper. Copper is well-known for having a high thermal conductivity.

In the same embodiment, the second temperature adjusting device may comprise a limited heat flow channel made of a medium thermal conductivity material and continuously contacting the continuous body along the optical axis over the second region. A medium specific thermal conductivity of the medium thermal conductivity material is lower than the high specific thermal conductivity of the high thermal conductivity material, but it may still be higher than the specific thermal conductivity of the nonlinear optical material. Further, the cross section and, thus, the effective thermal conductivity of the limited heat flow channel may be constant over the length of the limited heat flow channel along the optical axis. Thus, the limited heat flow channel will provide for a constant primary temperature gradient along the heat flow channel. This primary temperature gradient will then be transferred to the continuous body and result in the desired first temperature gradient in the second region of the continuous body. For example, the medium thermal conductivity material may consist of stainless steel known to have a rather low thermal conductivity for a metal but still a high thermal conductivity as compared to a nonlinear optical material.

The medium heat flow channel described here is a solid body. In a particular embodiment, the medium heat flow channel directly contacts the temperature equalizer, and the medium heat flow channel and the temperature equalizer have coplanar surfaces which directly or via an additional thin thermal conduction layer of a high thermal conductivity contact the continuous body. The coplanar surfaces may be commonly fabricated after joining the high thermal conductivity material of the temperature equalizer and the medium thermal conductivity material of the limited heat flow channel. In this way, a high flatness of the surface supporting the continuous body can be achieved. This reduces the risk of applying mechanical stress to the nonlinear optical material placed on this surface.

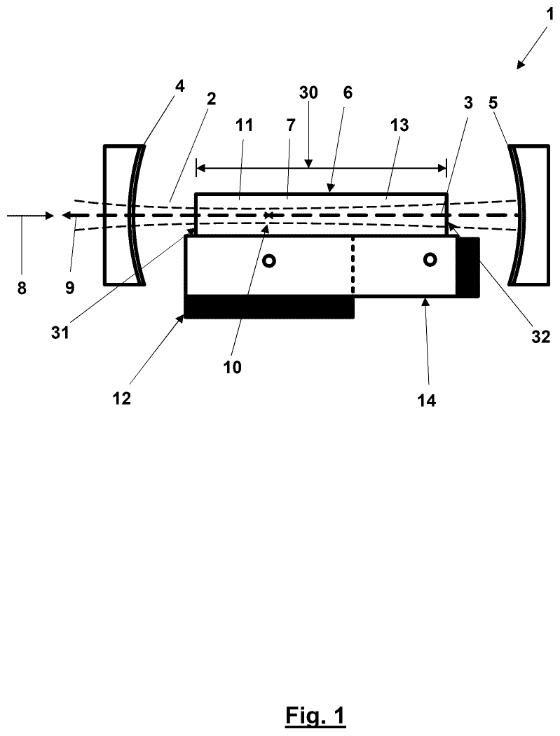

Now referring in greater detail to the drawings, the optical resonator 1 depicted in FIG. 1 comprises a resonator cavity 2 that extends along an optical axis 3 and that is here delimited by two mirrors 4 and 5. The mirror 4 is a partially transmitting coupling mirror for coupling light into and coupling light out of the cavity 2. The mirror 5 is a highly reflective mirror. Both mirrors 4 and 5 are concave. A continuous body 6 comprising a nonlinear optical material 7 is arranged in the resonator cavity 2 on the optical axis 3. The nonlinear optical material 7 may, for example, consist of KTiOPO₄, also designated as potassium titanyl phosphate (KTP), and the continuous body 6 may be a nonlinear crystal made of periodically poled KTP. The nonlinear optical material 7 serves for converting pump light 8 coupled into the resonator cavity 2 to light 9 of a different wavelength which can be coupled out of the resonator cavity 2. The concave mirrors 4 and 5 form coinciding beam waists 10 of the light 8, 9 of both different wavelengths within the continuous body 6. Here, in the subregion of the beam waists, the frequency conversion shall take place but requires a phase-matching of the light 8, 9 of the two different wavelengths propagating along the optical axis 3 back and forth in the resonator cavity 2 between the mirrors 4 and 5. This phase-matching is achieved by adjusting a temperature of the nonlinear optical material 7 in a first region 11 of the continuous body 6 by means of a first temperature adjusting device 12. In a neighboring second region 13 of the continuous body 6, a spatially constant temperature gradient along the optical axis 3 is adjusted by means of a second temperature adjusting device 14. The spatially constant temperature gradient is selected such as to tune the optical length of the resonator cavity 2 for resonance of the light 8, 9 of both different wavelengths.

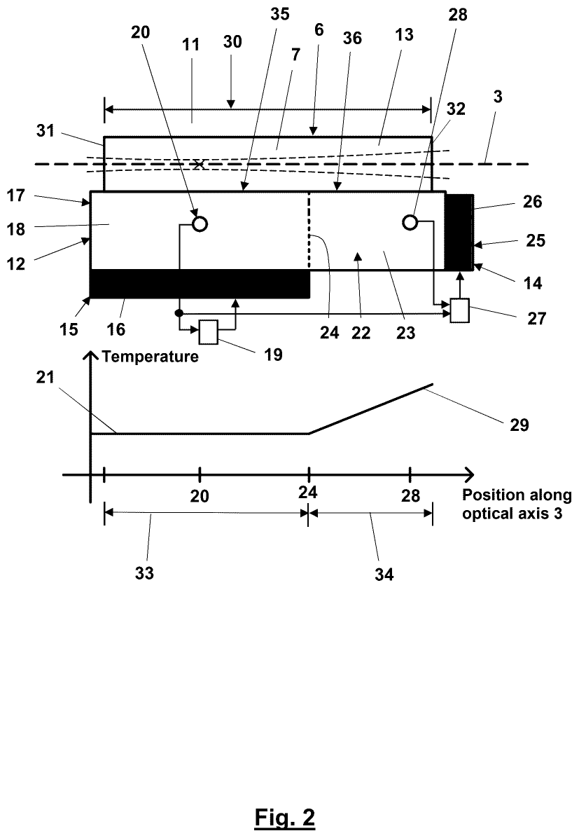

Details of the first temperature adjusting device 12 and the second temperature adjusting device 14 will now be discussed with reference to FIG. 2 showing these devices 12 and 14 attached to the continuous body 6 at the top, and a temperature distribution in the continuous body 6 along the optical axis 3 at the bottom. The first temperature adjusting device 12 comprises a heat sink and source 15, which is, here, implemented as a thermo-electric cooler 16 attached to a temperature equalizer 17. The temperature equalizer 17 is a solid body made of a high thermal conductivity material 18, like for example copper. The thermo-electric cooler is controlled by a temperature controller 19, for example a PID controller, in response to a signal of a temperature sensor 20 located in the temperature equalizer 18 to adjust the temperature of the temperature equalizer 17 to a desired or target temperature. This temperature, which is constant over the extension of the temperature equalizer 17 along the optical axis 3 results in a spatially constant temperature 21 in the continuous body 6 over the extension of its first region 11 along the optical axis 3.

The second temperature adjusting device 14 comprises a limited heat flow channel 22. The limited heat flow channel 22 is a solid body made of medium thermal conductivity material 23, like for example stainless steel. The limited heat flow channel 22 directly contacts the temperature equalizer 17 at an interface 24, and, with a constant cross section perpendicular to the optical axis 3 extends over the second region 13 of the continuous body 6 and beyond up to a heat sink and source 25 which is a further thermo-electric cooler 26, here. The heat sink and source 25 is operated by a temperature controller 27, for example a further PID controller, in response to the signal of the temperature sensor 20 in the temperature equalizer 18 and the signal of a further temperature sensor 28 which is arranged in the limited heat flow channel 22 at a position closer to the heat sink than source 25 than to the interface 24. The temperature controller 27 adjusts a desired temperature difference. Adjusting a higher temperature at the temperature sensor 28 than at the temperature sensor 20, results in a constant positive temperature gradient in the limited heat flow channel 22. The spatially constant temperature gradient 29 resulting in the second region 13 of the continuous body 6 is depicted at the bottom of FIG. 2.

The course of the temperature over the second region 13 begins with the spatially constant temperature 21 in the first region 11. However, there is no absolutely sharp kink between the spatially constant temperature 21 and the second region 13 of the temperature gradient 29 but a slightly curved course of the temperature at the interface 24. FIG. 2 also emphasizes that the first and second regions 11 and 13 are essential portions of the continuous body 6 which has an overall or total length 30 along the optical axis 3 between its end faces 31 and 32. In the embodiment depicted, a length 33 of the first portion 11 along the optical axis 3 is about 60% of the total length 30, and a length 34 of the second portion 13 is about 40% of the total length 30 of the continuous body 6.

Surfaces 35 and 36 of the temperature equalizer 17 and the limited heat flow channel 22, which support the first and second regions 11, 13 of the continuous body 6 are coplanar, and they have been machined together after attaching the medium thermal conductivity material 23 to the high thermal conductivity material 18 at the interface 24. This also applies to the further embodiments of the resonator 1 depicted in the other drawings.

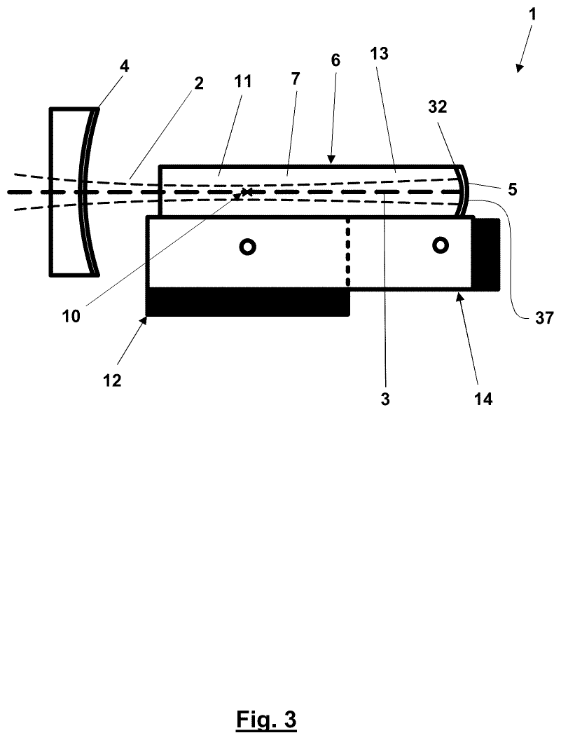

The resonator 1 depicted in FIG. 3 differs from that one shown in FIGS. 1 and 2 in that the high reflective mirror 5 is directly provided at the end face 33 of the continuous body 6 as a highly reflective coating 37 of this end face 33.

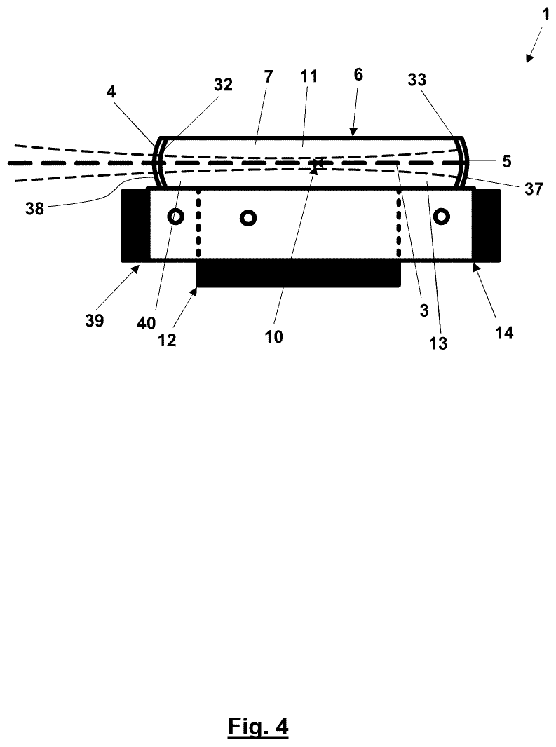

The optical resonator 1 depicted in FIG. 4 differs from that one shown in FIG. 3 in that the coupling mirror 4 is directly provided on the other end face 32 of the continuous body 6 as a partially transmitting coating 38 of that end face 32, and that a third temperature adjusting device 39 is provided at a side of the first temperature adjusting device 12 opposite to the second temperature adjusting device 14. The third temperature gradient adjusting device 39 is of an equal construction as the first temperature gradient adjusting device 14, and it is associated with a third region of the continuous body 6 extending along the optical axis 3. However, the extension of this third portion 40 along the optical axis 3 is shorter than the extension of the second portion 13 along the optical axis 3, here. A second spatially constant temperature gradient adjusted in the third region 40 by means of the third temperature adjusting device 39 provides for an additional degree of freedom in adapting the optical properties of the continuous body 6 allowing for achieving phase-matching and double-resonance of the light 8, 9 of the different wavelengths in the resonator cavity at the same time. The distance of the mirrors 4 and 5 at the cavity ends of the resonator cavity 2 is fixed to the total length 30 of the continuous body 6 along the optical axis 3 between its end faces 32 and 33, here, but this total length 30 is variable by, for example, setting the spatially constant temperature gradient in the third region and utilizing the resulting thermal expansion of the continuous body 6 along the optical axis 3.

The present disclosure is also suitable for more complex resonator cavity schemes like bow-tie cavities or different coupling mirrors for the light of the different wavelengths. For example, such a more complex resonator scheme may be used to generate vacuum squeezed states of light 9 a 1,064 nm wavelength by injecting a laser beam as the pump light 8 of 532 nm within the resonator 1.

Many variations and modifications may be made to the preferred embodiments of the invention without departing substantially from the spirit and principles of the invention. All such modifications and variations are intended to be included herein within the scope of the present invention, as defined by the following claims.

I claim:

1. A method of adapting optical properties of a continuous body arranged in a resonator cavity and comprising a nonlinear optical material to light of two different wavelengths passing through the continuous body along an optical axis, the continuous body having a total length along the optical axis, the method comprising:
adjusting a spatially constant temperature in a first region of the continuous body, the first region comprising the nonlinear optical material and extending over at least 20% of the total length of the continuous body along the optical axis; and
adjusting a first temperature gradient along the optical axis in a second region of the continuous body, the first temperature gradient starting from the spatially constant temperature in the first region, and the second region neighboring the first region on a first side of the first region and extending over at least 10% of the total length of the continuous body along the optical axis.

2. The method of claim 1, wherein the spatially constant temperature is selected such as to achieve phase-matching between the light of the two different wavelengths in the first region.

3. The method of claim 2, wherein the first temperature gradient is selected such as to achieve resonance of the light of both of the two different wavelengths in the resonator cavity.

4. The method of claim 3, further comprising adjusting a second temperature gradient in a third region of the continuous body, the third region neighboring the first region on a second side of the first region that faces away from the first side of the first region and extending over at least 20% of the total length of the continuous body, wherein the second temperature gradient is also selected such as to achieve resonance of the light of both of the two different wavelengths in the cavity.

5. The method of claim 1, wherein the spatially constant temperature is in a range from 18° C. to 150° C.

6. The method of claim 5, wherein the spatially constant temperature is in a range from 22° C. to 80° C.

7. The method of claim 5, wherein a value of the first temperature gradient is in a range from 0.5 K/mm to 10 K/mm.

8. The method of claim 7, wherein the first temperature gradient is in a range from 1 K/mm to 4 K/mm.

9. The method of claim 1, wherein the first temperature gradient is a spatially constant temperature gradient.

10. An optical resonator comprising:
a resonator cavity extending along an optical axis between at least two mirrors;
a continuous body comprising a nonlinear optical material arranged in the resonator cavity and having a total length along the optical axis;
a first temperature adjusting device configured for adjusting a spatially constant temperature in a first region of the continuous body, the first region comprising the nonlinear optical material and extending over at least 20% of the total length of the continuous body along the optical axis; and
a second temperature adjusting device configured for adjusting a first temperature gradient along the optical axis in a second region of the continuous body, the first temperature gradient starting from the spatially constant temperature in the first region, and the second region neighboring the first region on a first side of the first region and extending over at least 10% of the total length of the continuous body along the optical axis.

11. The optical resonator of claim 10, wherein the continuous body is a homogenous continuous body consisting of the nonlinear optical material.

12. The optical resonator of claim 10, further comprising a third temperature adjusting device configured for adjusting a second temperature gradient in a third region of the continuous body, the third region neighboring the first region on a second side of the first region that faces away from the first side of the first region and extending over at least 10% of the total length of the continuous body along the optical axis.

13. The optical resonator of claim 10, wherein the at least two mirrors are concave mirrors configured for focusing light coming out of a subregion of the first region of the continuous body back into that subregion.

14. The optical resonator of claim 10, wherein at least one of the at least two mirrors is provided on an end face of the continuous body.

15. The optical resonator of claim 10, wherein each temperature adjusting device comprises a temperature sensor, at least one of a heating element and a thermo-electric cooler, and a temperature controller.

16. The optical resonator of claim 10, wherein the first temperature adjusting device comprises a temperature equalizer made of a high thermal conductivity material and continuously contacting the continuous body along the optical axis over the first region.

17. The optical resonator of claim 16, wherein the high thermal conductivity material consists by more than 50% by weight of copper.

18. The optical resonator of claim 16, wherein the second temperature adjusting device comprises a limited heat flow channel made of a medium thermal conductivity material and continuously contacting the continuous body along the optical axis over the second region, wherein a medium thermal conductivity of the medium thermal conductivity material is higher than a thermal conductivity of the nonlinear optical material but lower than a high thermal conductivity of the high thermal conductivity material.

19. The optical resonator of claim 18, wherein the medium thermal conductivity material consists by more than 50% by weight of stainless steel.

20. The optical resonator of claim 18, wherein the medium heat flow channel directly contacts the temperature equalizer, and the medium heat flow channel and the temperature equalizer have coplanar surfaces contacting the continuous body.
